(19) United States
(12) Patent Application Publication
(10) Pub. No.: US 2022/0266850 A1
(43) Pub. Date: Aug. 25, 2022

(54) METHOD FOR OPERATING A MOTOR VEHICLE SYSTEM, CONTROL DEVICE, AND MOTOR VEHICLE

(71) Applicant: AUDI AG, Ingolstadt (DE)

(72) Inventors: Markus RUF, Waldstetten (DE); Michael BRECHTER, Möckmühl (DE)

(73) Assignee: AUDI AG, Ingolstadt (DE)

(21) Appl. No.: 17/637,716

(22) PCT Filed: Jul. 31, 2020
(86) PCT No.: PCT/EP2020/071656

§ 371 Date: Feb. 23, 2022

(30) Foreign Application Priority Data
Sep. 4, 2019 (DE) 10 2019 123 615.0

(51) Int. Cl. B60W 50/14; B60K 35/00

(52) U.S. Cl. CPC B60W 50/14; B60K 35/00; B60K 2370/166; B60K 2370/52; B60K 2370/111; B60K 2370/73

(57) ABSTRACT

The invention relates to a method for operating a motor vehicle system. A control device provides a basic mode, and establishes for the motor vehicle system a further operating mode that differs from the basic mode in that the further operating mode, compared to the basic mode, provides a predetermined additional operating function, and which further operating mode is currently blocked. The control device outputs media content containing at least one question about a topical context, wherein the media content is a quiz and/or asks the user for motor vehicle relevant data, and receives an input of information and checks this as to whether it meets a predefined match criterion that prescribes a match with a category of the topical context and/or an intended answer and is thus an answer to the at least one question from the output media content. The control device unblocks the blocked operating mode and thereby enables the additional operating function only if the predefined match criterion is met.

### TECHNICAL FIELD

The present disclosure relates to a method for operating a motor vehicle system, for example a navigation system, a display device, or a lighting system, for example headlights.

### BACKGROUND

In motor vehicles, it is increasingly the case that full equipment is available, even if a person has actually bought a vehicle with less equipment. The motor vehicle can then be designed to carry out a function of the full equipment, but this function is then blocked. A so-called “function on demand” is available as soon as it is paid for. In other words, an operating function is only enabled once the user of the motor vehicle pays for it.

US 2008/0154737 A1 describes techniques for identifying and marketing a set of secondary market products for a motor vehicle for a customer during a sales process, using one or more computers.

CN 106504055 A describes a method and a device for a virtual upgrade of automotive accessories.

A visualization system is known from U.S. Pat. No. 6,339,763 B1 in order to allow a user to select a motor vehicle and to superimpose images of various user-selected accessories on an image of the motor vehicle in order to cause a computer to display an image of the desired combination.

The methods described in the prior art are suitable for displaying hardware, for example special rims or other colors, to the user so that he can consider whether he would like to have these accessories. There is still no great incentive to try out additional functionalities, i.e. additional operating functions, since these can only be tried out against payment and consequently have to be purchased immediately.

### BRIEF DESCRIPTION OF THE DRAWINGS

The accompanying drawings, which are incorporated herein and form a part of the specification, illustrate the embodiments of the present disclosure, and together with the description, further serve to explain the principles of the embodiments and enable a person skilled in the pertinent art to make and use the embodiments, individually, or as a combination thereof.

FIG. 1 illustrates a method for operating a motor vehicle system.

### DETAILED DESCRIPTION

One object of the present disclosure is to increase the functionality of a motor vehicle.

The stated object is achieved by the method according to the present disclosure and by the devices according to embodiments in accordance with the independent claims. Advantageous refinements are provided by the dependent claims.

The present disclosure is based on the idea of providing a user of a motor vehicle with an additional operating function as soon as he has answered questions about a quiz and/or provides current, motor-vehicle-relevant data. In other words, through various activities, for example disclosure of data or participation in a quiz, preferably short periods of time can be “earned” for use. In addition to advantages for the user, for example for a driver of the motor vehicle, this also results in advantages for the motor vehicle manufacturer.

The user is encouraged to try out new operating functions, i.e. new “features.” There is a significantly higher rate of use of such operating functions. If, for example, the operating function is linked to a drone, in particular a flying drone, which can be enabled as a “reward” in order to take over transport deliveries, important tasks can be carried out. Such operating functions also include, for example, refueling the motor vehicle with a fuel cell in order to prevent the motor vehicle from “standing still.”

The method according to an embodiment for operating the motor vehicle system is carried out by a control device. A control device is understood to mean a device or a device component that is set up to receive signals, evaluate them, and generate control signals. The control device can be designed, for example, as a control device or control chip.

The control device provides a basic mode for the motor vehicle system which can be, for example, a lighting system, for example a headlight system, in which basic mode the usual functions of the headlights, for example high beam and dipped beam, can be set for example.

The control device establishes a further operating mode for the motor vehicle system that differs from the basic mode in that the further operating mode, compared to the basic mode, provides a predetermined additional operating function, wherein the additional operating mode is currently blocked. In other words, the additional operating mode provides an additional operating function that cannot currently be used, i.e. the use of the additional operating mode and thus the additional operating function are not enabled.

The control device outputs media content containing at least one question about a topical context, wherein the media content is a quiz and/or asks the user for motor-vehicle-relevant data.

The control device receives an input of information and checks this as to whether it meets a predefined match criterion that prescribes a match with a category of the topical context and/or an intended answer. The control device thus checks as to whether the input of information is an answer to the at least one question from the output media content. For example, current drive data of the motor vehicle and/or personal data of the user can be queried via a display device. Alternatively or additionally, the display device can output a quiz question, for example, and, for example, a voice input can be checked by means of speech recognition to check as to whether the user has answered this question correctly.

Only if the predefined match criterion is met does the control device unblock the blocked operating mode and thereby enable the additional operating function. Ideally, the enabling of the additional operating function is free of charge, so that the user of the motor vehicle has enough time to test the additional operating function.

The aforementioned advantages result here.

The additional operating function can preferably be a navigation function; and/or enables an additional headlight function to control at least one lamp of the headlights, preferably a matrix beam function of the headlight function; and/or a massage function of a motor vehicle seat; and/or a greater drive power of the motor; and/or the possibility of controlling the lamps of a lighting system and/or a display system in a special way; and/or a sun protection function of the display system or a sun visor.

The control device can preferably enable the further operating mode—and thus the additional operating function—only for a predetermined period of time. The user can first test the additional operating function and then decide whether he would like to keep the additional operating function.

According to a further, preferred embodiment of the method according to the present disclosure, the media content can request motor vehicle data and/or environmental data, and/or personal data. The media content can preferably describe a three-stage query and query motor vehicle data and environmental data and at least one piece of personal information about the user. In particular, the queried motor vehicle data can relate to drive data. The user can thus decide very transparently which data he would like to make available. Ideally, the “function on demand” can also be tailored to his needs.

The control device can predetermine the additional operating function preferably as a function of a property and/or an identity of the user, for example as a function of the age of the user, or, for example, after identification based on a fingerprint. For example, for an elderly man, a massage function is more useful than a special function of the headlights. Additionally or alternatively, the control device can predetermine the additional operating function as a function of a selection by the user from a plurality of additional operating functions of the blocked operating mode. In other words, the user can select a “reward.” In all variants, the result is that the motor vehicle is controlled in a particularly user-specific manner.

Ideally, the control device can only output the media content containing the at least one question if the user has given his consent. The user can thus control whether he would like to participate in the system for enabling the additional operating function.

The object set above is achieved by a control device which is set up to carry out one or more embodiments of the method according to the present disclosure. The control device can preferably have a processor device and/or a data memory. A processor device is understood to mean a device or a device component for electronic data processing. The processor device can for example comprise at least one microcontroller and/or at least one microprocessor. A program code for carrying out the method according to an embodiment can preferably be stored on this optional data memory. The program code can then be designed, when carried out by the processor device, to cause the control device to carry out one of the above-described embodiments of the method according to an embodiment. The control device can preferably be designed as a control chip, control device, or user program (“app”).

The above object is achieved by a motor vehicle which has an embodiment of the control device according to the present disclosure. The motor vehicle according to an embodiment is preferably designed as a car, in particular as a passenger car or truck or as a passenger bus or motorcycle.

The present disclosure also includes refinements of the control device according to an embodiment and of the method according to the present disclosure, which have features as were previously described in conjunction with the refinements of the method according to an embodiment. For this reason, the corresponding refinements of the control device according to the present disclosure and of the method according to the present disclosure are not described again herein.

The present disclosure also includes combinations of the features of the described embodiments.

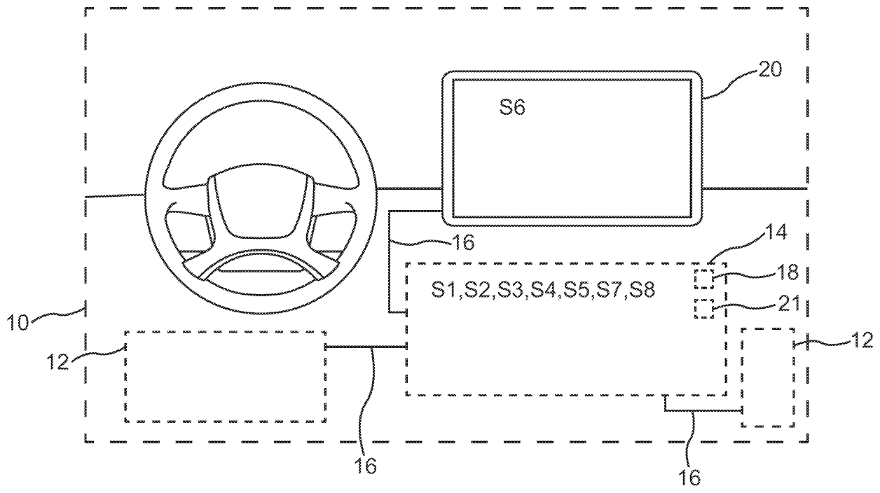

Embodiments of the present disclosure are described below. For this purpose, the single FIGURE FIG. 1 shows a schematic representation of an embodiment of the method and the devices according to the present disclosure.

The embodiments explained below are preferred embodiments of the present disclosure. In the embodiments, the described components of the embodiments each represent individual features of the present disclosure which should be considered independently of one another and which each develop the embodiments further independently of one another. The disclosure is therefore also intended to include combinations of the features of the embodiments other than those presented. Furthermore, the described embodiments may also be supplemented by further features of the present disclosure as already described.

In the drawings, the same reference signs refer to functionally identical elements.

The FIGURE illustrates the principle of the method according to the present disclosure and the device according to the present disclosure using an embodiment. For this purpose, the FIGURE shows a motor vehicle 10, for example a passenger car, having two motor vehicle systems 12 and a control device 14, for example.

In the example of the FIGURE, one of the two motor vehicle systems 12 can be, for example, a lighting system, i.e. a lighting device, for example a headlight system; and the other motor vehicle system 12 may be a navigation device, for example. The communication between the individual components takes place via data communication connections 16, preferably wired data communication connections 16, such as a data bus of the motor vehicle 10 in each case. Suitable wireless data communication connections are also known to a person skilled in the art from the prior art, for example Bluetooth connections or WLAN connections. The motor vehicle 10 of the FIGURE also has a display device 20, for example a display device having a screen.

The control device 14 of the example in the FIGURE has an optional processor device 18 and/or a data memory 21. The control device can provide each of the motor vehicle systems 12 in a corresponding basic mode (S1), i.e. each of the motor vehicle systems 12 can be operated by the user in the basic mode. In the basic mode of the exemplary headlight system, the user can set all the necessary functions of the headlights, for example parking lights, high beam, and dipped beam. In the basic mode of the exemplary navigation device, the basic mode can, for example, provide the usual functions of a navigation device, for example searching for geographical coordinates, calculating travel routes, and displaying the travel history containing navigation instructions.

Both motor vehicle systems 12 can, for example, have a user program (“app”) or have access to such a user program that can be stored in the data memory 21 of the control device 14, or such a “function on demand” can be available in a server, for example. For example, a “function on demand” can be available for the exemplary headlight system, with which, for example, light-emitting diodes of the headlights can be controlled in such a way that, for example, if oncoming traffic is detected, a corresponding segment on the road is darkened so that oncoming traffic is not dazzled. For example, a “function on demand” can be available for the exemplary navigation device, with which the navigation device uses a special design for displaying the map, for example while the navigation device is running, and/or can provide different images for the ego vehicle, for example. For both of the exemplary motor vehicle systems 12, these additional “functions on demand” can initially be blocked but can be purchased.

For establishing S2 that such further operating modes with additional operating functions are available, the control device 14 can, for example, carry out a corresponding query on a data server external to the motor vehicle (not shown in the FIGURE) or establish software modules in its own data memory 21 or in a data memory of the corresponding motor vehicle system 12. It can preferably be provided that, for example, a type of “trial subscription” can be used free of charge for, for example, two weeks. Ideally, it can be provided that the control device 14 first checks as to whether a user of the motor vehicle 10 has consented to a quiz being offered to him, for example, or whether such a trial subscription can be offered as a “reward” in exchange for enabling, for example, motor-vehicle-relevant data. Such consent can be asked, for example, before the motor vehicle 10 is started, or such consent can be specified by the user in a user profile stored in the control device 14. It can be provided, for example, that when the motor vehicle 10 is started or when the user profile is set up, it is asked whether the user would like to take part in such an action. The user can then confirm whether he agrees or whether he, for example, permanently rejects it.

A special selection of operating functions can preferably be provided i.e. can be predetermined (S3) for the method. The selection of operating functions can depend, for example, on a property or an identity of the user. For example, if the user has entered his date of birth in a profile and the control device 14 uses the profile to establish that the person is an elderly man, the headlight function and/or optionally a special massage seat function of the motor vehicle seat can be selected; however, a function for the extended range of ambient lighting and the extended navigation system function are not selected. For example, if the user is a young lady, the additional operating function of the navigation system and/or that of the special ambient light can be selected, but not the massage function and the headlight function, for example. If such a selection is made as a function of an identity of the user, this can be established (S4), for example, in that a fingerprint sensor of the motor vehicle, for example, which can be arranged in the center console, captures a fingerprint and forwards the digital fingerprint to the control device 14, and the control device 14 can then recognize the identity on the basis of the fingerprint.

In the example of the FIGURE, for example, the operating function of additional designs can be available as an additional operating function of the exemplary navigation device and the so-called “matrix beam function” for the headlight system. For example, a plurality of media files, each containing a media content, can be stored in the data memory 21. Some of these files can, for example, describe media content that outputs a quiz question on a topical context as a question, for example the question “What is the capital of Peru?” The control device 14 can transmit the corresponding file to the display device 20 (S5), and the display device 20 can then output the media content (S6). In other words, the control device 14 outputs the media content by means of the display device 20 (S6). The output S6 can for example take place in such a way that a pop-up window showing the question appears on the screen of the display device 20. As an alternative to the output S6 by a display device 20, the media content can be output, for example, through a loudspeaker system, in which case, for example, an electronic voice can then pronounce the question.

The topical context of the exemplary question in the FIGURE has the word “Lima” as the intended answer. The intended answer or solution can also be stored in the data memory 21, for example. An input of information can be received (S7) in that, for example, a text input is received by means of a keyboard, a touch-sensitive screen, or a voice input. The voice input or text input can then be compared, for example, with the intended answer, and in the example of the FIGURE it is established during this check S8 that the tester has said the correct answer. Optionally, the exemplary display device 20 can then, for example, display a further pop-up window with the information “You are a winner.”

As a “reward”, the exemplary headlight function, for example, and/or the exemplary navigation function can then be enabled for 20 hours (S9).

According to a further embodiment, which can also be described with reference to the FIGURE, the basic sequences can run as already described for the previous example, only the differences being discussed below.

Alternatively or additionally to the quiz question, the topical context can be directed to specific motor vehicle data; for example current motor vehicle data are initially queried in three stages, for example drive data such as current power, mass flows, fuel pressure of an internal combustion engine, fuel consumption, and/or a torque. For example, the display device 20 can display the question “Would you like to transmit your data for the purpose of internal, anonymized statistics?” (S6), and after confirmation, i.e. after consent to the transmission of the data, the control device 14 can access the corresponding data and transmit them, for example, to a motor vehicle manufacturer who can use the data for, for example, anonymized, internal statistics.

In this case, the topical context “authorized use of drive data” and the input of information S7 can then be the consent of the user, and the consent given can be checked during the check S8.

In a second stage, for example, environmental data can be queried in this way, for example geographical coordinates where the motor vehicle is currently located, a speed of the motor vehicle 10, and/or an outside temperature.

In the third stage, personal data can then be queried analogously, for example a number of people in motor vehicle 10 and/or coordinates of motor vehicle 10 and/or travel/driving times.

In a further embodiment, which can also be explained with reference to the FIGURE, a user, for example a driver, can first be asked whether he would like to take part in “additional activities.” This can be done, for example, via a human-machine interface (“HMI”), for example via a voice request. The further method can only be activated if the response is positive.

A quiz with questions and answers can be displayed as an example (S6). If there is a plurality of questions, for example, advertising content can be placed in between. A prize of the exemplary quiz can be, for example, the use of bookable vehicle functionalities, for example navigation, matrix beam, massage function of the seat, or a somewhat greater drive power. The prize can preferably be made available for a limited period of time.

Preferably, there can be not only one prize option, but rather the exemplary driver can ideally choose from at least two different prizes.

Alternatively or additionally, disclosure of data can be requested, preferably a three-stage disclosure of data. These can be:

drive data (for example power, parameters of the battery (for example I, T), data of a fuel cell, for example mass flows, an electrical voltage, a volume or data from an internal combustion engine, for example a fuel pressure; and/or

environmental data, for example an altitude, a temperature, for example an outside temperature or an ambient temperature, or a motor vehicle speed; and/or

personal data, for example a number of people in the motor vehicle 10, coordinates and/or travel and/or driving times.

After the disclosure during, for example, a specific period of time, for example 20 hours, a vehicle functionality can also be selected for use.

The FIGURE thus shows an arrangement and a method for analyzing and reporting back data in a motor vehicle 10.

Overall, the examples show how the present disclosure can provide an arrangement and a method for analyzing and reporting back data in a motor vehicle 10.

Through various activities (disclosure of data, participation in quizzes or the like), short periods of time for use (function on demand) can be “earned.” In addition to the advantages for the user, there are also advantages for the motor vehicle manufacturer. The advantages described above result.

For example, a link with a flying drone is possible (taking over the transport delivery=>enabling the function as a “reward”); refueling one or more motor vehicles with fuel cells to avoid getting stranded=>also here “reward” for taking over refueling functions; other tasks that are important for the motor vehicle manufacturer can possibly also be rewarded accordingly by enabling function on demand.

1.-8. (canceled)

9. A method for operating a motor vehicle system, wherein the method is performed by a control device, the control device comprising:
providing a basic mode for the motor vehicle system;
establishing for the motor vehicle system a further operating mode that differs from the basic mode in that the further operating mode, compared to the basic mode, provides a predetermined additional operating function, wherein the further operating mode is currently blocked;
outputting media content including at least one question about a topical context, wherein the media content is a quiz and/or asks the user for motor-vehicle-relevant data,
receiving an input of information and checking whether the information meets a predefined match criterion that prescribes a match with a category of the topical context and/or an intended answer, wherein the match is an answer to the at least one question from the output media content; and
unblocking the blocked operating mode and thereby enabling the additional operating function only if the predefined match criterion is met.

10. A method according to claim 9, wherein the additional operating function is at least one of a navigation function, an additional headlight function for controlling at least one lamp of the headlights, a massage function, a greater drive power, the possibility of controlling the lamps of a lighting system, a display system in a special way, a sun protection function of the display system or a sun visor.

11. A method according to claim 9, wherein the control device enables the further operating mode for only a predetermined period of time.

12. A method according to claim 9, wherein the media content asks for at least one of motor vehicle data, or environmental data, or personal data, wherein the media content describes a three-stage query and asks for motor vehicle data and environmental data and at least one piece of personal information, wherein the motor vehicle data relates to drive data.

13. A method according to claim 9, wherein the control device predetermines the additional operating function based on at least one of a property, identity of the user, or based on a selection by the user from a plurality of additional operating functions of the blocked operating mode.

14. A method according to claim 9, wherein the control device only outputs the media content containing the at least one question if the user has given their consent.

15. A control device for operating a motor vehicle system comprising:
a memory; and
at least one processor operative to access the memory and perform operations comprising:
provide a basic mode for the motor vehicle system;
establish for the motor vehicle system a further operating mode that differs from the basic mode in that the further operating mode, compared to the basic mode, provides a predetermined additional operating function, wherein the further operating mode is currently blocked;
output media content containing at least one question about a topical context, wherein the media content is a quiz and/or asks the user for motor-vehicle-relevant data;
receive an input of information and checking whether it meets a predefined match criterion that prescribes a match with a category of the topical context and/or an intended answer, wherein the match is an answer to the at least one question from the output media content; and
unblock the blocked operating mode and thereby enables the additional operating function only if the predefined match criterion is met.

16. A motor vehicle comprising:
a control device comprising:
a memory; and
at least one processor operative to access the memory and perform operations comprising:
provide a basic mode for the motor vehicle system;
establish for the motor vehicle system a further operating mode that differs from the basic mode in that the further operating mode, compared to the basic mode, provides a predetermined additional operating function, wherein the further operating mode is currently blocked;
output media content containing at least one question about a topical context, wherein the media content is a quiz and/or asks the user for motor-vehicle-relevant data;
receive an input of information and checking whether it meets a predefined match criterion that prescribes a match with a category of the topical context and/or an intended answer, wherein the match is an answer to the at least one question from the output media content; and
unblock the blocked operating mode and thereby enables the additional operating function only if the predefined match criterion is met.
